(19) United States
(12) Patent Application Publication
(10) Pub. No.: US 2014/0129853 A1
(43) Pub. Date: May 8, 2014

(54) Advertising power over ethernet (POE) capabilities among nodes in a POE system using type-length-value (TLV) structures

(71) Applicant: Broadcom Corporation, Irvine, CA (US)

(72) Inventors: Wael Diab, San Francisco, CA (US); Martin McNarney, Morgan Hill, CA (US)

(73) Assignee: Broadcom Corporation, Irvine, CA (US)

(21) Appl. No.: 13/998,515

(22) Filed: Nov. 7, 2013

Related U.S. Application Data
(60) Provisional application No. 61/723,503, filed on Nov. 7, 2012.
(60) Provisional application No. 61/727,036, filed on Nov. 15, 2012.

(51) Int. Cl. G06F 1/26

(52) U.S. Cl. CPC G06F 1/266
USPC 713/310

(57) ABSTRACT

Embodiments of the present disclosure provide systems and methods to enable a Power Source Equipment (PSE) and a Powered Device (PD) advertise their identity, capabilities, and neighbors by exchanging IEEE Standard 802.1AB Link Layer Discovery Protocol (LLDP) information in Ethernet frames. Each Ethernet frame contains one or more LLDP Data Units (LLDPDUs) corresponding to a sequence of type-length-value (TLV structure) structures. The PSEs and PDs utilize optional TLV Structures from among the one or more LLDPDUs to advertise their PoE capabilities.

### CROSS-REFERENCE TO RELATED APPLICATIONS

This patent application claims the benefit of U.S. Provisional Patent Application No. 61/723,503, filed Nov. 7, 2012 and U.S. Provisional Patent Application No. 61/727,036, filed Nov. 15, 2012, each of which is incorporated herein by reference in its entirety.

### BACKGROUND

1. Field of Disclosure

The present disclosure generally relates to a Power over Ethernet (PoE) system, and more specifically, advertising of PoE capabilities among nodes in the PoE system using type-length-value (TLV) structures in an Ethernet frame.

2. Related Art

A local area network (LAN) is a computer network that interconnects multiple computers in a limited area such as, a home, school, computer laboratory, or office building to provide some examples, using network media. A conventional Ethernet LAN typically provides high speed data communications between multiple conventional communication nodes that operate according to the Institute of Electrical and Electronics Engineers (IEEE) 802.3 Ethernet Standard. The multiple conventional communication nodes can include one or more conventional printers, desktop computers, laptop computers, cell phones, gaming consoles, or any combination thereof. Depending on how the connections are established and secured in a LAN, and the distance involved, a LAN may also be classified as a metropolitan area network (MAN) or a wide area network (WAN).

The multiple conventional communication nodes can advertise their identity, capabilities, and neighbors within the LAN using the IEEE Standard 802.1 AB Link Layer Discovery Protocol (LLDP) by exchanging LLDP information in conventional Ethernet frames. Each conventional Ethernet frame contains one LLDP Data Unit (LLDPDU) corresponding to a sequence of conventional type-length-value (TLV) structures. The conventional TLV Structures can include a first group of TLV Structures, referred to as standard TLV Structures, and, in some situations, include a second group of TLV Structures, referred to as optional TLV Structures. These optional TLV Structures can be used to further advertise identities, capabilities, or neighbors within the LAN in manners not specified by the LLDP.

Manufacturers and/or designers of LANs are incorporating power providing capabilities into Ethernet LANs to provide a Power over Ethernet (PoE) LAN. The PoE LAN includes a conventional Power Source Equipment (PSE) for providing power and data communications over a communication link to a conventional Powered Device (PD). Currently, there are relatively limited number of TLV structures that are available for use by the conventional PSE and the conventional PD to advertise their identities, capabilities, or neighbors within the conventional PoE LAN. As the manufacturers and/or the designers expand the capabilities of the PoE LAN, these limited number of TLV structures are inadequate to advertise the capabilities of the conventional PSE and the conventional PD in the conventional PoE LAN.

### BRIEF DESCRIPTION OF THE DRAWINGS/FIGURES

The present disclosure is described with reference to the accompanying drawings. In the drawings, like reference numbers indicate identical or functionally similar elements. Additionally, the left most digit(s) of a reference number identifies the drawing in which the reference number first appears.

FIG. 1 is a block diagram of a Power over Ethernet (PoE) system according to an exemplary embodiment of the present disclosure;

FIG. 2 illustrates a more detailed figure of the power transfer from Power source equipment (PSE) to t Powered Device (PD) in the PoE system according to an exemplary embodiment of the present disclosure;

FIG. 3 graphically illustrates an LLDP Ethernet frame structure that can be implemented as part of the PoE system according to an exemplary embodiment of the present disclosure;

FIG. 4 is a block diagram of a transceiver module that can be implemented as part of the PoE system for communicating the exemplary Ethernet frame according to an exemplary embodiment of the present disclosure; and

FIG. 5 illustrates an exemplary Power over Ethernet LAN according to an exemplary embodiment of the present disclosure.

The present disclosure will now be described with reference to the accompanying drawings. In the drawings, like reference numbers generally indicate identical, functionally similar, and/or structurally similar elements. The drawing in which an element first appears is indicated by the leftmost digit(s) in the reference number.

### DETAILED DESCRIPTION OF THE DISCLOSURE

The following Detailed Description refers to accompanying drawings to illustrate exemplary embodiments consistent with the disclosure. References in the Detailed Description to “one exemplary embodiment,” “an exemplary embodiment,” “an example exemplary embodiment,” etc., indicate that the exemplary embodiment described can include a particular feature, structure, or characteristic, but every exemplary embodiment can not necessarily include the particular feature, structure, or characteristic. Moreover, such phrases are not necessarily referring to the same exemplary embodiment. Further, when a particular feature, structure, or characteristic is described in connection with an exemplary embodiment, it is within the knowledge of those skilled in the relevant art(s) to affect such feature, structure, or characteristic in connection with other exemplary embodiments whether or not explicitly described.

The exemplary embodiments described herein are provided for illustrative purposes, and are not limiting. Other exemplary embodiments are possible, and modifications can be made to the exemplary embodiments within the spirit and scope of the disclosure. Therefore, the Detailed Description is not meant to limit the disclosure. Rather, the scope of the disclosure is defined only in accordance with the following claims and their equivalents.

Embodiments of the disclosure can be implemented in hardware, firmware, software, or any combination thereof. Embodiments of the disclosure can also be implemented as instructions stored on a machine-readable medium, which can be read and executed by one or more processors. A machine-readable medium can include any mechanism for storing or transmitting information in a form readable by a machine (e.g., a computing device). For example, a machine-readable medium can include non-transitory machine-readable mediums such as read only memory (ROM); random access memory (RAM); magnetic disk storage media; optical storage media; flash memory devices; and others. As another example, the machine-readable medium can include transitory machine-readable medium such as electrical, optical, acoustical, or other forms of propagated signals (e.g., carrier waves, infrared signals, digital signals, etc.). Further, firmware, software, routines, instructions can be described herein as performing certain actions. However, it should be appreciated that such descriptions are merely for convenience and that such actions in fact result from computing devices, processors, controllers, or other devices executing the firmware, software, routines, instructions, etc.

The following Detailed Description of the exemplary embodiments will so fully reveal the general nature of the disclosure that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

For purposes of this discussion, the term “module” shall be understood to include at least one of software, firmware, and hardware (such as one or more circuits, microchips, or devices, or any combination thereof), and any combination thereof. In addition, it will be understood that each module can include one, or more than one, component within an actual device, and each component that forms a part of the described module can function either cooperatively or independently of any other component forming a part of the module. Conversely, multiple modules described herein can represent a single component within an actual device. Further, components within a module can be in a single device or distributed among multiple devices in a wired or wireless manner.

Overview of the Disclosure

Embodiments of the present disclosure provide systems and methods to enable Power Source Equipment (PSE) and Powered Devices (PDs) within a Power over Ethernet (PoE) system, such as a PoE LAN to provide an example, to advertise their identity, capabilities, and neighbors by exchanging IEEE Standard 802.1AB Link Layer Discovery Protocol (LLDP) information in Ethernet frames. Each Ethernet frame contains one or more LLDP Data Units (LLDPDUs) corresponding to a sequence of type-length-value (TLV structure) structures. The present disclosure outlines new, optional TLV Structures from among the one or more LLDPDUs that are not presently available in a conventional Ethernet LAN. The PSE and PDs of the present disclosure use these newly outlined optional TLV Structures to advertise their PoE capabilities.

Exemplary Power Over Ethernet (PoE) System

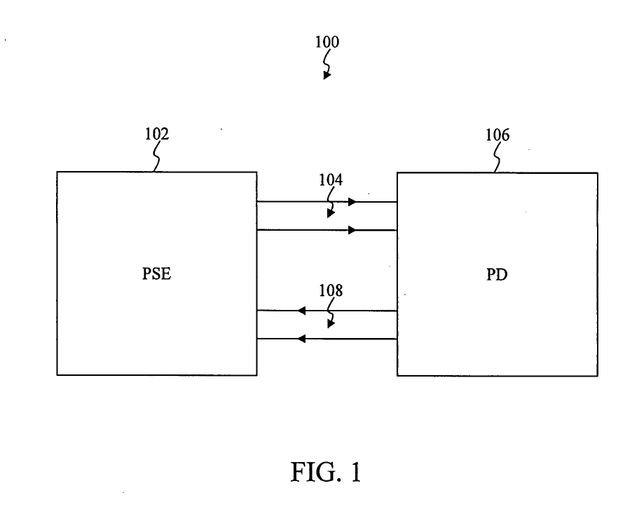

FIG. 1 is a block diagram of a Power over Ethernet (PoE) system according to an exemplary embodiment of the present disclosure. A PoE system 100 includes conductor pairs 104 and 108 for providing power and data communications between Power Source Equipment (PSE) 102 and a Powered Device (PD) 106. The PSE 102 provides PoE to the PD 106 according to a known PoE standard, such as the IEEE 802.3af standard, the IEEE 802.3 at standard, the IEEE 802.3 standard, a legacy PoE transmission, and/or any suitable type of PoE transmission standard to provide some examples. The PSE 102 and PD 106 also include data transceivers that operate according to a known communication standard, such as a 10BASE-T, a 100BASE-TX, a 1000BASE-T, a 10GBASE-T, and/or any other suitable communication standard to provide some examples.

The conductor pairs 104 and 108 can carry data communications and/or power transmissions between the PSE 102 and the PD 106. In an exemplary embodiment, each of the conductor pairs 104 and 108 each include one or more twisted wire pairs, such as a category 5 cable which is commonly used for Ethernet communications. In this exemplary embodiment, the PSE 102 and PD 106 can support different configurations and arrangements of the one or more twisted wire pairs for data communication and/or power transmission. For example, the PSE 102 and the PD 106 can utilize two or four of the twisted wire pairs for 10BASE-T and/or 100BASE-TX and 1000BASE-T and/or 10GBASE-T, respectively. As another example, the PSE 102 and the PD 106 can utilize two of the twisted wire pairs for IEEE 802.3af, IEEE 802.3 at standard, and/or updated IEEE 802.3 at PoE. As a further example, the PSE 102 and the PD 106 can utilize four of the twisted wire pairs to effectively double power capabilities of IEEE 802.3af, IEEE 802.3 at standard, and/or updated IEEE 802.3 at PoE. In this exemplary embodiment, the PSE 102 and PD 106 can use similar twisted wire pairs for data communication and power transmission; however, the use of different twisted wire pairs for data communication and power transmission is possible as will be recognized by those skilled in the relevant art(s) without departing from the spirit and scope of the present disclosure.

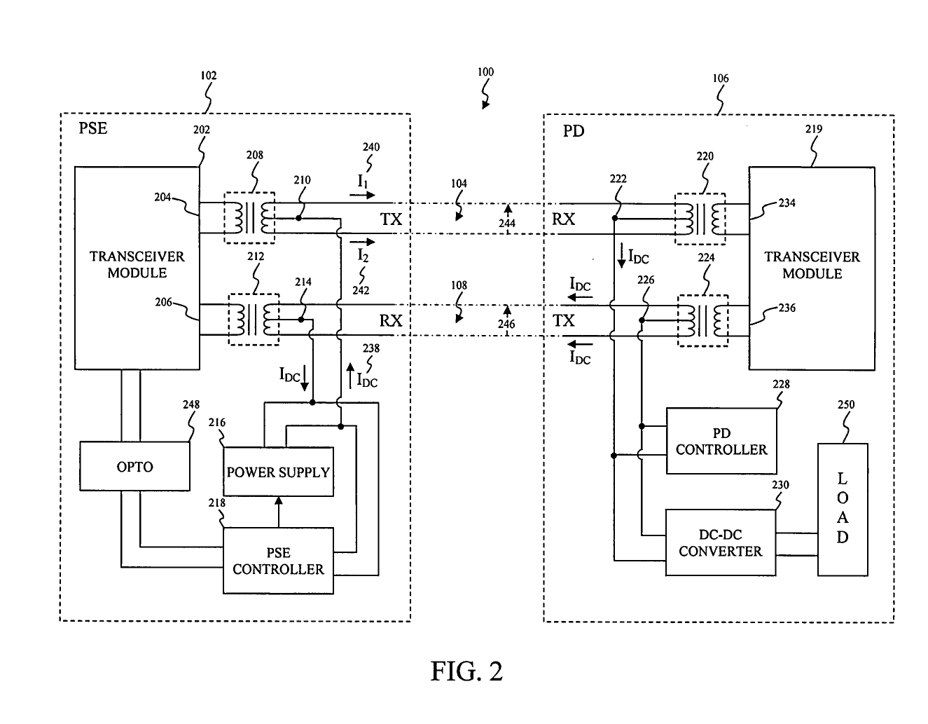

FIG. 2 illustrates a more detailed figure of the power transfer from a Power source equipment (PSE) to a Powered Device (PD) in a PoE system according to an exemplary embodiment of the present disclosure. More specifically, FIG. 2 provides a more detailed circuit diagram of the PoE system 100 for providing power transmission and data communications between the PSE 102 and a PD 106 over the conductor pairs 104 and 108. The PSE 102 includes a transceiver module 202 having full duplex transmit and receive capability through a transmit port 204 and a receive port 206. A first transformer 208 provides data from the transmit port 204 to the first conductor pair 104 for communication to the PD 106. Likewise, a second transformer 212 provides data communicated by the PD 106 over the second conductor pair 108 to the receive port 206. The transformers 208 and 212 pass the data between the transceiver module 202 and the PD 106, but isolate power transmission from the transmit port 204 and the receive port 206.

The first transformer 208 includes primary and secondary windings, where the secondary winding includes a center tap 210. Likewise, the second transformer 212 includes primary and secondary windings, where the secondary winding includes a center tap 214. The power supply 216 provides power that is applied across the center tap 210 of the first transformer 208 and/or the center tap 214 of the second transformer 212. The center tap 210 is connected to a first output of the power supply 216, and the center tap 214 is connected to a second output of the power supply 216. As such, the transformers 208 and 212 isolate the power provided from the power supply 216 from the transmit port 204 and the receive port 206 of the transceiver module 202. In an exemplary embodiment, the power supply 216 provides a DC output voltage of approximately 48 volts, but other voltages could be used depending on the voltage/power requirements of the PD 106.

The PSE 102 further includes a PSE controller 218 that controls the power supply 216 based on the dynamic needs of the PD 106. More specifically, the PSE controller 218 measures the voltage, current, and temperature of the outgoing and incoming DC supply lines so as to characterize the power requirements of the PD 106. The PSE controller 218 also detects and validates a compatible PD, determines a power classification signature for the validated PD, supplies power to the PD, monitors the power, and reduces or removes the power from the PD when the power is no longer requested or required. During detection, if the PSE finds the PD to be non-compatible, the PSE can prevent the application of power to that PD device, protecting the PD from possible damage.

Still referring to FIG. 2, the PD 106 includes a transceiver module 219 having full duplex transmit and receive capability through a transmit port 236 and a receive port 234. A third transformer 224 provides data from the transmit port 236 to the second conductor pair 108 for communication to the PD 106. Likewise, a second transformer 212 provides data communicated by the PD 106 over the first conductor pair 104 to the receive port 234. The transformers 208 and 212 pass the data between the transceiver module 219 and the PSE 102, but isolate power transmission from the transmit port 236 and the receive port 234.

The third transformer 220 includes primary and secondary windings, where the secondary winding includes a center tap 222. Likewise, the fourth transformer 224 includes primary and secondary windings, where the secondary winding includes a center tap 226. The center taps 222 and 226 supply the power carried over conductors 104 and 108 to a representative load 250 of the PD 106. A DC-DC converter 230 may be optionally inserted before the load 250 to step down the voltage as necessary to meet the voltage requirements of the PD 106. Further, multiple DC-DC converters 230 may be arrayed in parallel to output multiple different voltages (3 volts, 5 volts, 12 volts) to supply different loads 250 of the PD 106.

The PD 106 further includes a PD controller 228 that monitors the power transmission on the PD side of the PoE configuration. The PD controller 228 further provides the necessary impedance signatures on the return conductor 108 during initialization, so that the PSE controller 218 will recognize the PD as a valid PoE device, and be able to classify its power requirements.

During ideal operation, a direct current (I_{DC}) 238 flows from the power supply 216 through the first center tap 210, and divides into a first current (I₁) 240 and a second current (I₂) 242 that is carried over conductor pair 104. The first current (I₁) 240 and the second current (I₂) 242 then recombine at the third center tap 222 to reform the direct current (I_{DC}) 238 so as to power the PD 106. On return, the direct current (I_{DC}) 238 flows from PD 106 through the fourth center tap 226, and divides for transport over conductor pair 108. The return DC current recombines at the second center tap 214, and returns to the power supply 216. As discussed above, data transmission between the PSE 102 and the PD 106 occurs substantially simultaneously with the power transmission. Accordingly, a first communication signal 244 and/or a second communication signal 246 are simultaneously carried via the conductor pairs 104 and 108 between the PSE 102 and the PD 106.

The conductor pairs 104 and 108 can carry the first communication signal 244 and/or the second communication signal 246 and/or the direct current (I_{DC}) 238, including the first current (I₁) 240 and the second current (I₂) 242, between the PSE 102 and the PD 106.

In an exemplary embodiment, each of the conductor pairs 104 and 108 each include one or more twisted wire pairs, such as a category 5 cable which is commonly used for Ethernet communications. In this exemplary embodiment, the PSE 102 and PD 106 can support different configurations and arrangements of the one or more twisted wire pairs for data communication and/or power transmission. For example, the PSE 102 and the PD 106 can utilize two or four of the twisted wire pairs to carry the first communication signal 244 and/or the second communication signal 246. As another example, the PSE 102 and the PD 106 can utilize two or four of the twisted wire pairs to carry the direct current (I_{DC}) 238, including the first current (I₁) 240 and the second current (I₂) 242. In this exemplary embodiment, the PSE 102 and PD 106 can use the same two twisted wire pairs for data communication and power transmission; however, different twisted wire pairs can be used for data communication and power transmission as will be recognized by those skilled in the relevant art(s) without departing from the spirit and scope of the present disclosure.

Exemplary LLDP Ethernet Frame Structure that can be Used in the PoE System

The PSE 102 and the PD 106 can advertise their supported configurations as well as their identity, capabilities, and neighbors by exchanging LLDP information in Ethernet frames. Each Ethernet frame contains one or more LLDP Data Units (LLDPDUs) corresponding to a sequence of type-length-value (TLV) structures.

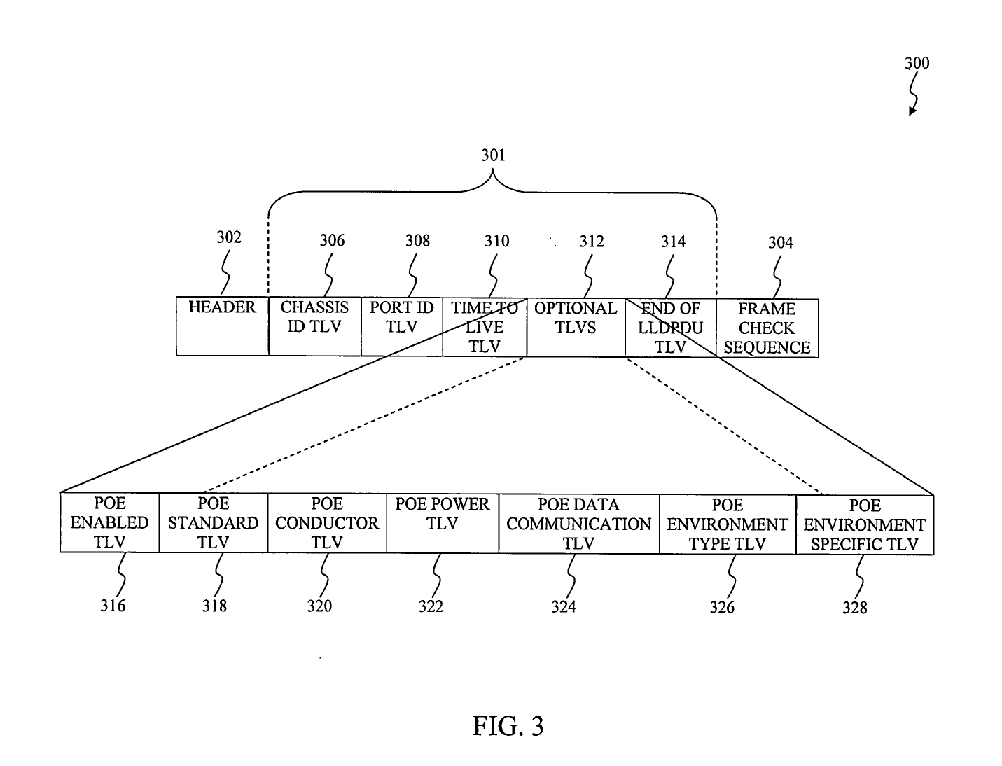

FIG. 3 graphically illustrates an LLDP Ethernet frame structure that can be implemented as part of the PoE system according to an exemplary embodiment of the present disclosure. A PSE, such the PSE 102 to provide an example, advertises its identity, capabilities, and neighbors by exchanging LLDP information in an LLDP Ethernet frame 300 with a PD, the PD 106 to provide an example. Although not described, the PD can also advertise its identity, capabilities, and neighbors by exchanging LLDP information in the LLDP Ethernet frame 300 with the PSE in a substantially similar manner. The LLDP Ethernet frame 300 includes variable number of information elements referred to as TLV Structures 301 in between a header sequence 302 and a frame check sequence 304. The header 302 and the frame check sequence 304 represent conventional elements of the LLDP Ethernet frame 300. Conventionally, the header 302 includes a preamble that is used for frame synchronization, PSE and PD address information, and an indication of a protocol that is encapsulated in the TLV Structures 301. Conventionally, the frame check sequence 304 represents a checksum that is used by the PSE and/or the PD for error detection.

Each of the TLV Structures 301 includes fields for Type, Length, and Value. The Type field identifies the information being communicated by the PSE to the PD, the Length Field indicates the length of the information being communicated by the PSE to the PD, and the Value Field represents the information being communicated by the PSE to the PD. The TLV Structures 301 include a first group of TLV Structures, referred to as standard TLV Structures. The standard TLV Structures include a Chassis ID TLV Structure 306, a Port ID TLV Structure 308, a Time to Live TLV Structure 310, and an End of LLDPDU TLV Structure 314. The Chassis ID TLV Structure 306 identifies a chassis of the PSE. The Port ID TLV Structure 308 identifies a specific port of the PSE. The Time to Live TLV Structure 310 identifies a length of time that the LLDP Ethernet frame 300 is valid. The End of LLDPDU TLV Structure 314 indicates an end of the LLDP Ethernet frame 300 to indicate that no further processing of TLV Structures is needed. These standard TLV Structures are specified by the LLDP and, in an exemplary embodiment, are included in the LLDP Ethernet frame 300.

The TLV Structures 301 can include a second group of TLV Structures, referred to as optional TLV Structures 312, which are not specified by the LLDP, but can be used to further advertise identities, capabilities, or neighbors of the PSE and/or PD in manners not specified by the LLDP, for example, to advertise PoE capabilities of the PSE and/or the PD.

The optional TLV Structures 312 can be used to generate a profile of the PSE and/or PD that can be used to configure the power to be provided by the PSE to the PD as well as data communications between the PSE and the PD. The optional TLV Structures 312 can include one or more of: a PoE enabled TLV Structure 316, a PoE standard TLV Structure 318, a PoE Conductor TLV Structure 230, a PoE Power TLV Structure 322, a PoE Data Communication TLV Structure 324, a PoE Environment Type TLV Structure 326, and/or a PoE Environment Specific TLV Structure 328. It should be noted that various combinations of the PoE enabled TLV Structure 316, the PoE standard TLV Structure 318, the PoE Conductor TLV Structure 230, the PoE Power TLV Structure 322, the PoE Data Communication TLV Structure 324, the PoE Environment Type TLV Structure 326, and/or the PoE Environment Specific TLV Structure 328 are possible that will be apparent to those skilled in the relevant art(s) without departing from the spirit and scope of the present disclosure.

The PoE enabled TLV Structure 316 identifies whether the PSE and/or the PD are PoE enabled. For example, the PoE enabled TLV Structure 316 identifies whether the PSE is PoE compliant, namely whether the PSE is capable of delivering power to the PD. Alternatively, or in addition to, the PoE enabled TLV Structure 316 identifies whether the PD is PoE compliant, namely whether the PD is capable of accepting power from the PSE. In some situations, a non-PoE enabled device, often referred to as a legacy device, can be coupled to the PSE. In these situations, it is beneficial for the non-PoE enabled device to communicate its inability to accept power from the PSE to prevent the PSE from providing power to the non-PoE enabled device.

The PoE standard TLV Structure 318 can indicate whether the PSE and/or the PD support the IEEE 802.3af standard, the IEEE 802.3 at standard, the IEEE 802.3 standard, a legacy PoE transmission, and/or another suitable type of PoE transmission standard that will be apparent to those skilled in the relevant art(s) without departing from the spirit and scope of the present disclosure. For example, the original IEEE 802.3af standard provides up to 15.4 W of power to each PD. In this example, when the PoE standard TLV Structure 318 indicates that the PSE supports the original IEEE 802.3af standard, then the PD can request up to 15.4 W of power be delivered by the PSE. In this example, when the PoE standard TLV Structure 318 indicates that the PD supports the original IEEE 802.3af standard, then the PSE can deliver up to 15.4 W of power to the PD. As another example, the updated IEEE 802.3 at standard, also known as PoE+, provides up to 25.5 W of power to each PD. In this example, when the PoE standard TLV Structure 318 indicates that the PSE supports the IEEE 802.3 at standard, then the PD can request up to 25.5 W of power be delivered by the PSE. In this example, when the PoE standard TLV Structure 318 indicates that the PD supports the IEEE 802.3 at standard, then the PSE can deliver up to 25.5 W of power to the PD. In an exemplary embodiment, the PoE standard TLV Structure 318 can be used identify a “type” of the PSE and/or of the PD. For example, a “type 1” device is compliant with the IEEE 802.3af standard and a “type 2” device is compliant with the IEEE 802.3 at. However, other types may be possible for the PSE and the PD to indicate compliance with other known PoE standards.

The PoE Conductor TLV Structure 230 indicates whether the PSE and/or the PD are capable of operating in a two-pair and/or a four-pair configuration for transferring power and optionally which pairs are to be used for transferring power and/or communicating data. For example, manufacturers and/or designers of PoE LANs have begun to offer PoE solutions that utilize all four pairs of the category 5 cable to provide up to 51 W of power instead of 25.5 W over two pairs of the category 5 cable as outlined in the updated IEEE 802.3 at standard. In this example, the PoE Conductor TLV Structure 230 can indicate that the PSE and/or the PD is capable of utilizing all four pairs of the category 5 cable to transfer power.

The PoE Power TLV Structure 322 indicates a power profile of the PSE, such as its power providing capabilities to provide an example, and/or a power profile of the PD, such as its power requirements to provide some examples. The power profile can include parameters that are specific to the power itself, such as voltage and/or current levels. For example, the original IEEE 802.3af standard provides up to 15.4 W of power. In this example, the power profile of the PD can indicate the voltage and/or the current to be provided by the PSE to generate this 15.4 W of power. In this example, the power profile of the PSE can indicate the different combinations of voltages and/or currents that can be provided to the PD to generate this 15.4 W of power.

The PoE Data Communication TLV Structure 324 can indicate data communication standards that are supported by the PSE and/or the PD. For example, the PoE Data Communication TLV Structure 324 can indicate whether the PSE and/or the PD support the 10BASE-T, the 100BASE-TX, the 1000BASE-T, the 10GBASE-T, and/or any other suitable communication standard. The PoE Data Communication TLV Structure 324 can also indicate coding schemes for the data communication which are supported by the PSE and/or the PD. For example, PoE Data Communication TLV Structure 324 can also indicate whether the PSE and/or the PD support various multi-level transmit (MLT) coding and/or various pulse amplitude modulation (PAM) coding to provide some examples. The PoE Data Communication TLV Structure 324 can further indicate data rates for the data communication which are supported by the PSE and/or the PD. The PoE Data Communication TLV Structure 324 can yet further indicate noise sensitivities of the PSE and the PD. Different applications have varying sensitivity to interference from noise sources depending upon their capabilities. For example, 10GBASE-T is commonly recognized to be extremely sensitive to crosstalk. The PoE Data Communication TLV Structure 324 can yet further indicate which pair or pairs of the communication link are to be used for the data communication.

The PoE Environment Type TLV Structure 326 indicates an operating environment of the PSE and/or the PD. The manufacturers and/or the designers of the PoE LAN have begun to offer PoE solutions in new environments, such as an automotive environment or an industrial environment to provide some examples.

The PoE Environment Specific TLV Structure 328 can indicate functions that are available to the PSE and/or the PD while operating in the operating environment. For example, the PSE and/or the PD can be incorporated within or coupled to another electrical device or host device such as an IP security camera; a network router; a network webcam; a network intercom/paging/public address system; a VoIP phone a wireless access point; an industrial or automotive device, such as a sensor, a controller, and/or a meter to provide some examples; an access control and help-point system, such as an intercom, an entry card, and/or a keyless entry to provide some examples; a lighting controller, a Point of Sale (POS) kiosk; a physical security device and controller; or any other suitable PoE capable device. In this example, the PoE Environment Specific TLV Structure 328 can indicate specific functions that are related to this other electrical device or host device.

LLDP Memory Module that can be Implemented as Part of the PoE System for Communicating the Exemplary LLDP Ethernet Frame Structure

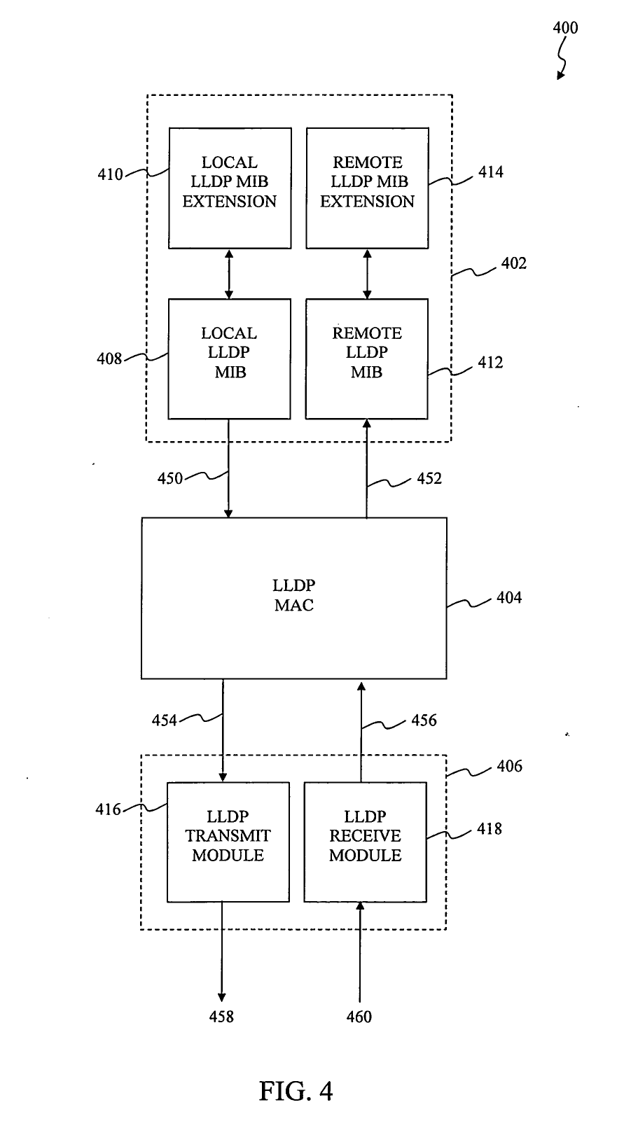

FIG. 4 is a block diagram of a transceiver module that can be implemented as part of the PoE system for communicating the exemplary Ethernet frame according to an exemplary embodiment of the present disclosure. A PSE, such as the PSE 102 to provide an example, and/or a PD, such as the PD 106 to provide an example, includes a transceiver module 400 for transmitting and/or receiving one or more LLDP data packets in Ethernet frames, such as the LLDP Ethernet frame 300 to provide an example. The transceiver module 400 includes an LLDP memory module 402, an LLDP media access controller (MAC) 406, and an LLDP physical layer device (PHY) 408. The transceiver module 400 can represent an exemplary embodiment of the transceiver module 202 and/or the transceiver module 219.

The LLDP memory module 402 manages and/or stores information contained in the one or more LLDP data packets into various data stores, such as a local management information base (MIB) and/or a remote MIB. When the transceiver module 400 is implemented as part of the PSE, the local MIB contains network information that pertains to the PSE while the remote MIB contains network information that pertains to the PD. Otherwise, when the transceiver module 400 is implemented as part of the PD, the local MIB contains network information that pertains to the PD while the remote MIB contains network information that pertains to the PSE.

The LLDP memory module 402 includes a local LLDP MIB 408, an optional local LLDP MIB extension 410, a remote LLDP MIB 412, and/or an optional remote LLDP MIB extension 414. The identity of the local device, the capabilities of the local device and/or the neighbors of the local device which are specified by the LLDP are stored within the local LLDP MIB 406 in various standard TLV structures, such as one or more of the standard TLV Structures of the LLDP Ethernet frame 300 as described in FIG. 3 to provide an example. Optionally, the identity of the local device, the capabilities of the local device, and/or the neighbors of the PSE which not are specified by the LLDP are stored within the optional local LLDP MIB extension 410 in various optional TLV structures, such as one or more of the optional TLV Structures of the LLDP Ethernet frame 300 as described in FIG. 3 to provide an example. The identity of the remote device, the capabilities of the remote device and/or the neighbors of the remote device which are specified by the LLDP are stored within the remote LLDP MIB 412 in various standard TLV structures, such as one or more of the standard TLV Structures of the LLDP Ethernet frame 300 as described in FIG. 3 to provide an example. Optionally, the identity of the remote device, the capabilities of the remote device, and/or the neighbors of the PSE which not are specified by the LLDP are stored within the optional remote LLDP MIB extension 414 in various optional TLV structures, such as one or more of the optional TLV Structures of the LLDP Ethernet frame 300 as described in FIG. 3 to provide an example.

The LLDP MAC 404 can perform Layer 2 MAC functionality such as error correction/detection, encapsulating/de-encapsulating, routing, and other processing according to the LLDP. The LLDP MAC can retrieve one or more TLV structures 450 from the LLDP memory module 402. The one or more TLV structures 450 can include one or more standard TLV Structures corresponding to the local device that are stored in the local LLDP MIB 408 and/or one or more optional TLV Structures corresponding to the local device that are stored in the optional local LLDP MIB extension 410. The LLDP MAC 404 can process the TLV structures 450 using the Layer 2 functionality to provide one or more LLDP data packets 454 to the LLDP PHY 406.

The LLDP MAC 404 can process one or more LDDP packets 456 that are received from the LLDP PHY 406 using the Layer 2 functionality. The LLDP MAC 404 can provide one or more TLV structures 452 for storage in the LLDP memory module 402. The one or more TLV structures 450 can include one or more standard TLV Structures corresponding to the remote device that are stored in the remote LLDP MIB 412 and/or one or more optional TLV Structures corresponding to the remote device that are stored in the optional remote LLDP MIB extension 414.

The LLDP PHY 406 provides an electrical, a mechanical, and/or a procedural interface to communicate the one or more LLDP data packets between the local and the remote devices. The LLDP PHY 406 can perform Layer 1 physical layer (PHY) functionality such as modulation/demodulation, equalization, frequency translation, multiplexing, and other processing according to the LLDP. The LLDP PHY 406 includes an LLDP transmit module 416 and an LLDP receive module 418. The LLDP transmit module 416 can process the one or more LLDP data packets 454 using the Layer 1 functionality to provide a transmit signal 458 for communication to the remote device. The LLDP receiver module 418 can process a receive signal 460 that is received from the remote device using the Layer 1 functionality to provide the one or more LLDP data packets 456.

Exemplary Power Over Ethernet (PoE) LAN

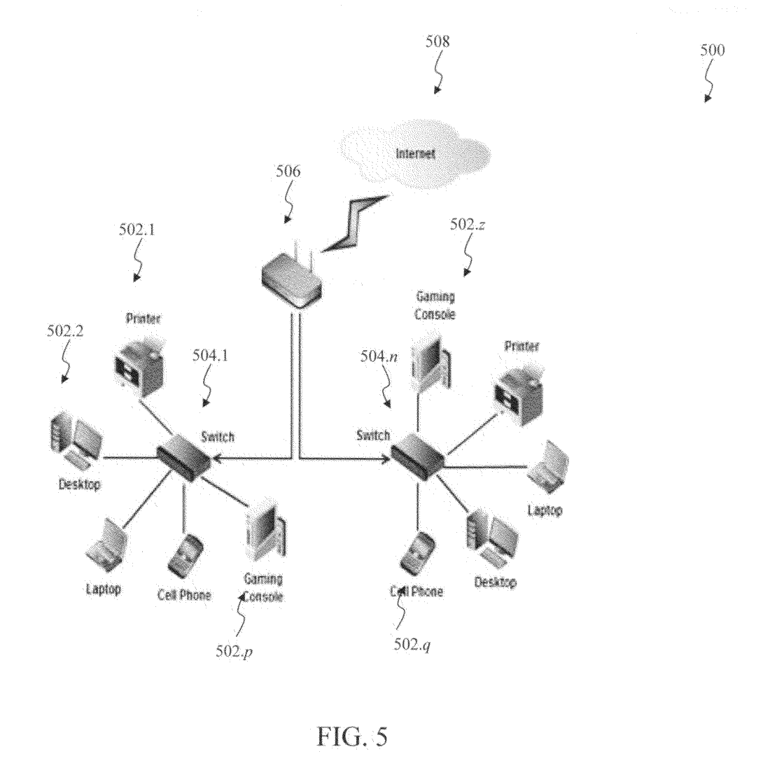

FIG. 5 illustrates an exemplary Power over Ethernet LAN according to an exemplary embodiment of the present disclosure. An exemplary Power over Ethernet (PoE) LAN 500 includes Power Source Equipment (PSE), such as switches 504.1 through 504.n, for providing power and data communications to one or more Powered Devices (PDs), such as communication nodes 502.1 through 502.z. The communication nodes 502.1 through 502.z can include one or more printers, desktop computers, laptop computers, cell phones, gaming consoles, or any combination thereof. The communication nodes 502.1 through 502.z and the switches 504.1 through 504.n can include data transceivers that operate according to a known communications standard, such as a 10BASE-T, a 100BASE-TX, a 1000BASE-T, a 10GBASE-T, and/or any other suitable communication standard to provide some examples. Additionally, the switches 504.1 through 504.n can provide power to some, or all, of the communication nodes 502.1 through 502.z according to a known PoE standard, such as the IEEE 802.3af standard, the IEEE 802.3 at standard, the updated IEEE 802.3 at standard, also known as PoE+, the IEEE 802.3 standard, a legacy PoE transmission, and/or any suitable type of PoE transmission standard to provide some examples.

A first group of the communication nodes 502.1 through 502.p are communicatively coupled to a first switch 504.1 from among the switches 504.1 through 504.n and an n^{th} group of the communication nodes 502.q through 502.z are communicatively coupled to an n^{th} switch 504.n from among the switches 504.1 through 504.n. The first switch 504.1 and the n^{th} switch 504.n are communicatively coupled to a wireless router 506 for communicating data between the first group of the communication nodes 502.1 through 502.p and the second group of the communication nodes 502.q through 502.z, respectively, and the Internet 508.

Some of the first group and/or the second group of the communication nodes 502.1 through 502.z can have different PoE capabilities. In an exemplary embodiment, some of the first group and/or the second group of the communication nodes 502.1 through 502.z represent legacy devices that are non-PoE compatible. In another exemplary embodiment, some of the first group and/or the second group of the communication nodes 502.1 through 502.z are PoE compliant according to different PoE standards. For example, a first communication node from among the communication nodes 502.1 through 502.z can be compliant with the IEEE 802.3af standard while a second communication node from among the communication nodes 502.1 through 502.z can be compliant with the IEEE 802.3 at standard. In a further exemplary embodiment, some of the first group and/or the second group of the communication nodes 502.1 through 502.z are capable of operating different configurations, such as a two-pair and/or a four-pair configuration to provide some examples, for transferring power and/or communicating data.

The communication nodes 502.1 through 502.z and the switches 504.1 through 504.n can advertise their identity, capabilities, and/or neighbors within the LAN using the IEEE Standard 802.1AB Link Layer Discovery Protocol (LLDP). The communication nodes 502.1 through 502.z and the switches 504.1 through 504.n advertise their identity, capabilities, and neighbors by exchanging LLDP information in Ethernet frames, such as the Ethernet Frame 300 to provide an example. Each Ethernet frame contains one or more LLDP Data Units (LLDPDUs) corresponding to a sequence of type-length-value (TLV) structures, such the standard TLV Structures and/or the optional TLV Structures as discussed above in FIG. 3.

### CONCLUSION

It is to be appreciated that the Detailed Description section, and not the Abstract section, is intended to be used to interpret the claims. The Abstract section can set forth one or more, but not all exemplary embodiments, of the present disclosure, and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

It will be apparent to those skilled in the relevant art(s) that various changes in form and detail can be made therein without departing from the spirit and scope of the disclosure. Thus the present disclosure should not be limited by any of the above-described exemplary embodiments, but should be defined only in accordance with the following claims and their equivalents.

What is claimed is:

1. A Power Source Equipment (PSE) for providing data communication and power transmission to a Powered Device (PD) in a Power over Ethernet (PoE) system, the PSE being communicatively coupled to the PD by a communication cable having four-pairs of conductors, the PSE comprising:
a Link Layer Discovery Protocol (LLDP) physical layer device (PHY) configured to receive a Link Layer Discovery Protocol (LLDP) data packet from the PD using at least two-pairs of conductors from among the four-pairs of conductors;
a LLDP media access controller (MAC) configured to de-encapsulate a type-length-value (TLV) structure from the LLDP data packet, the TLV structure indicating whether the PD is capable of using the four-pairs of conductors for the power transmission; and
a PSE controller configured to cause a power supply to provide the power transmission to the PD using the four-pairs of conductors when the TLV structure indicates that the PD is capable of using the four-pairs of conductors for the power transmission.

2. The PSE of claim 1, wherein the PSE controller is further configured to cause the power supply to provide the power transmission to the PD using only two of the four-pairs of conductors when the TLV structure indicates that the PD is not capable of using the four-pairs of conductors for the power transmission.

3. The PSE of claim 2, wherein the LLDP MAC is configured to de-encapsulate the TLV structure from an Ethernet frame within the LLDP data packet, and further comprising:
a remote LLDP management information base (MIB) configured to store the TLV structure.

4. The PSE of claim 1, wherein the TLV structure is an optional TLV structure that is not specified by the LLDP.

5. The PSE of claim 1, wherein the LLDP MAC is further configured to encapsulate a second TLV structure within a second LLDP data packet, the second TLV structure advertising a capability of the PSE to support the four-pairs of conductors for the power transmission.

6. The PSE of claim 5, further comprising:
a local LLDP management information base (MIB) configured to store the second TLV structure, and
wherein the LLDP MAC is configured to encapsulate the second TLV structure within an Ethernet frame to provide the second LLDP data packet.

7. The PSE of claim 1, wherein the power supply is configured to provide approximately twice as much power over the four-pairs of conductors than it can provide over only two-pairs of conductors from among the four-pairs of conductors.

8. A Powered Device (PD) for receiving data communication and power transmission from a Power Source Equipment (PSE) in a Power over Ethernet (PoE) system, the PD being communicatively coupled to the PSE by a communication cable having four-pairs of conductors, the PD comprising:
a Link Layer Discovery Protocol (LLDP) physical layer device (PHY) configured to receive a LLDP data packet from the PSE using at least two-pairs of conductors from among the four-pairs of conductors;
a LLDP media access controller (MAC) configured to de-encapsulate a type-length-value (TLV) structure from the LLDP data packet, the TLV structure indicating whether the PSE is capable of using the four-pairs of conductors for the power transmission; and
a load configured to receive the power transmission from the PSE using the four-pairs of conductors when the TLV structure indicates that the PSE is capable of using the four-pairs of conductors for the power transmission.

9. The PD of claim 8, wherein the load is further configured to receive the power transmission from the PSE using only two of the four-pairs of conductors when the TLV structure indicates that the PSE is not capable of using the four-pairs of conductors for the power transmission.

10. The PD of claim 9, wherein the LLDP MAC is configured to de-encapsulate the TLV structure from an Ethernet frame within the LLDP data packet, and further comprising:
a remote LLDP management information base (MIB) configured to store the TLV structure.

11. The PD of claim 8, wherein the TLV structure is an optional TLV structure that is not specified by the LLDP.

12. The PD of claim 8, wherein the LLDP MAC is further configured to encapsulate a second TLV structure within a second LLDP data packet, the second TLV structure advertising a capability of the PD to support the four-pairs of conductors for the power transmission.

13. The PD of claim 11, further comprising:
a remote LLDP management information base (MIB) configured to store the second TLV structure; and
wherein the LLDP MAC is configured to encapsulate the second TLV structure within an Ethernet frame to provide the second LLDP data packet.

14. A method of advertising capabilities of supporting four-pairs of conductors in a Power over Ethernet (PoE) system, comprising:
providing, by a Powered Device (PD), a Link Layer Discovery Protocol (LLDP) data packet using at least two-pairs of conductors from among the four-pairs of conductors;
de-encapsulating, by a Power Source Equipment (PSE), a type-length-value (TLV) structure from the LLDP data packet, the TLV structure indicating whether the PD is capable of using the four-pairs of conductors for the power transmission; and
providing, by the PSE, power transmission to the PD using the four-pairs of conductors when the TLV structure indicates that the PD is capable of using the four-pairs of conductors for power transmission.

15. The method of claim 14, wherein the providing further comprises:
providing the power transmission to the PD using only two-pairs of conductors from among the four-pairs of conductors when the TLV structure indicates that the PD is not capable of using the four-pairs of conductors for the power transmission.

16. The method of claim 14, wherein providing the LLDP data packet comprises:
encapsulating the TLV structure within an Ethernet frame.

17. The method of claim 14, wherein the TLV structure is an optional TLV structure that is not specified by the LLDP.

18. The method of claim 14, further comprising:
providing, by the PSE, a second LLDP data packet using the at least two-pairs of conductors from the four-pairs of conductors; and
de-encapsulating, by the PD, a second TLV structure from the second LLDP data packet, the second TLV structure indicating whether the PSE is capable of using the four-pairs of conductors for the power transmission.

19. The method of claim 14, further comprising:
receiving, by the PD, the power transmission from the PSE using the four-pairs of conductors when the TLV structure indicates that the PSE is capable of using the four-pairs of conductors for the power transmission.

20. The method of claim 14, further comprising:
receiving, by the PD, the power transmission from the PSE using only two-pairs of conductors from among the four-pairs of conductors when the TLV structure indicates that the PSE is not capable of using the four-pairs of conductors for the power transmission.
